(19) United States
(12) Patent Application Publication
(10) Pub. No.: US 2012/0315124 A1
(43) Pub. Date: Dec. 13, 2012

(54) Hose Retention Apparatus and Method Thereof

(76) Inventors: Garrett Frink, Weare, NH (US); Norman Frink, Henniker, NH (US)

(21) Appl. No.: 13/490,999

(22) Filed: Jun. 7, 2012

Related U.S. Application Data
(60) Provisional application No. 61/494,212, filed on Jun. 7, 2011.

(51) Int. Cl. B25J 1/04; B23P 17/04

(52) U.S. Cl. 414/800; 29/428; 294/137; 294/165

(57) ABSTRACT

A hose retention apparatus and method of retaining a hose is provided. The hose retention apparatus includes a hose holding structure having an interior portion sized to hold a cross-sectional area of a hose without contacting a fluid path within the hose. A substantially rigid connecting member has a first end and a second end, wherein the first end is connected to the hose holding portion. A handle is secured to the second end of the substantially rigid connecting member.

### CROSS REFERENCE TO RELATED APPLICATION

This application claims benefit of U.S. Provisional Application Ser. No. 61/494,212, entitled, “Hose Retention Apparatus and Method Thereof,” filed Jun. 7, 2011, the entire disclosure of which is incorporated herein by reference.

### FIELD OF THE DISCLOSURE

The present disclosure is generally related to retaining devices and more particularly is related to a hose retention apparatus and method thereof.

### BACKGROUND OF THE DISCLOSURE

Hoses are used in many industries for a variety of applications. Generally, hoses are used for the convenient transportation of a fluid from one location to another. For example, hoses are used to transport water for fighting fires, food substances in commercial food operations, and even waste in waste management operations. Commonly, the hose is subjected to an environment where it may become dirty or unsanitary, such as a hose used with removing waste from a septic tank. Once dirty, undesirable contact with the hose is difficult to avoid, since the hose may need to be moved, such as being placed on a truck or in a storage area. Additionally, it is often difficult to maneuver or control the movement or location of a hose when it is in use. For example, when waste is pumped through the hose, the quantity of waste may make the hose move unexpectedly. Controlling the hose in a situation like this often requires substantial physical force, which may subject a worker to dirty, unsanitary, and dangerous conditions.

Thus, a heretofore unaddressed need exists in the industry to address the aforementioned deficiencies and inadequacies.

### SUMMARY OF THE DISCLOSURE

Embodiments of the present disclosure provide a hose retention apparatus and method thereof. Briefly described, in architecture, one embodiment of the system, among others, can be implemented as follows. The hose retention apparatus includes a hose holding structure having an interior portion sized to hold a cross-sectional area of a hose without contacting a fluid path within the hose. A substantially rigid connecting member has a first end and a second end, wherein the first end is connected to the hose holding portion. A handle is secured to the second end of the substantially rigid connecting member.

The present disclosure can also be viewed as providing methods of retaining hoses. In this regard, one embodiment of such a method, among others, can be broadly summarized by the following steps: securing a hose holding structure about a cross-sectional area of a hose without contacting a fluid path within the hose; connecting a substantially rigid connecting member having a first end and a second end to the hose holding portion at the first end; securing a handle to the second end of the substantially rigid connecting member; and controlling a movement of at least a portion of the hose with the hose holding structure, the substantially rigid connecting member, and the handle.

The present disclosure can also be viewed as providing methods of building a hose retaining apparatus. In this regard, one embodiment of such a method, among others, can be broadly summarized by the following steps: providing a hose holding structure sized to be positioned about a cross-sectional area of a hose without contacting a fluid path within the hose; connecting a substantially rigid connecting member having a first end and a second end to the hose holding portion at the first end; and securing a handle to the second end of the substantially rigid connecting member.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a cross-sectional illustration of a hose retention apparatus, in accordance with a first exemplary embodiment of the present disclosure.

FIG. 2 is a cross-sectional illustration of a hose retention apparatus with a hose-clamping element, in accordance with the first exemplary embodiment of the present disclosure.

FIG. 3 is a cross-sectional illustration of a hose retention apparatus with a hose-clamping element and a locking element, in accordance with the first exemplary embodiment of the present disclosure.

FIG. 4 is a cross-sectional illustration of a hose retention apparatus, in accordance with a second exemplary embodiment of the present disclosure.

FIG. 5 is a cross-sectional illustration of a hose retention apparatus, in accordance with a third exemplary embodiment of the present disclosure.

FIG. 6 is a side view illustration of a hose retention apparatus, in accordance with the third exemplary embodiment of the present disclosure.

FIG. 7 is a cross-sectional illustration of a hose retention apparatus, in accordance with a fourth exemplary embodiment of the present disclosure.

FIG. 8 is an illustration of a hose retention apparatus in use, in accordance with a fifth exemplary embodiment of the present disclosure.

FIG. 9 is a flowchart illustrating a method of retaining a hose, in accordance with the first exemplary embodiment of the disclosure.

FIG. 10 is a flowchart illustrating a method of building a hose retaining apparatus, in accordance with the first exemplary embodiment of the disclosure.

### DETAILED DESCRIPTION

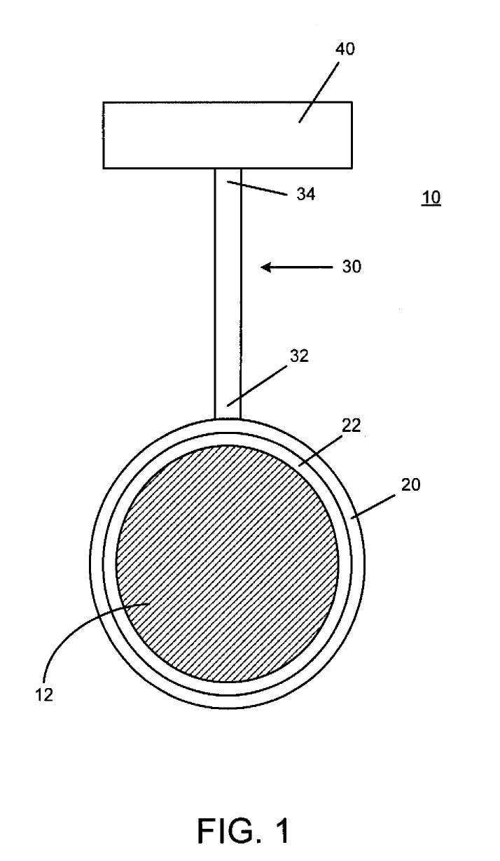

FIG. 1 is a cross-sectional illustration of a hose retention apparatus 10, in accordance with a first exemplary embodiment of the present disclosure. The hose retention apparatus 10, which may be referred to simply as, ‘apparatus 10’ includes a hose holding structure 20. The hose holding structure 20 has an interior portion 22 sized to hold a cross-sectional area of a hose 12 without contacting a fluid path within the hose 12. A substantially rigid connecting member 30, having a first end 32 and a second end 34 is secured to the hose holding portion 20 at the first end 32. A handle 40 is secured to the substantially rigid connecting member 30 at the second end 34.

The hose retention apparatus 10 may be used in a variety of industries to retain, hold, move, or otherwise manipulate the location or movement of a hose 12 having a fluid path. In accordance with this disclosure, the fluid path of the hose 12 may be characterized as the pathway formed by the hose 12 and within the walls of the hose 12 for transporting fluids or other substantially viscous materials, such as raw sewage. For example, the apparatus 10 may be used within the waste removal and disposal industry, which commonly uses hoses 12 to move waste from one location to another. Within the sewage treatment industry, it is common for hoses 12 to be used for removing waste from a septic tank, or other sewage storage area. A hose 12 may be lowered into the septic tank and a pump, usually on-board with a sewage truck, creates a vacuum within the hose 12 to remove the waste. Due to the suction that the vacuum creates, paired with the weight of the waste being moved, the hose 12 may become difficult to retain in a specific location. Similarly, the relatively large size and length of hoses 12 used within the waste treatment industry are often burdensome to move. Often, a worker will be required to pull the hose 12 by placing it over his or her shoulder or underneath his or her arm. This often results in the inability to remain clean, as well as the inability to carry another object with a free hand.

In accordance with this disclosure, the hose 12 may be any type of pipe, tubing, or substantially hollow structure that is either designed or intended to carry a quantity of fluid, or fluidly-movable material, from one location to another. The hose 12 may be constructed from rubber, plastic, canvas, metal, or any other material, or combination thereof. For example, the hose 12 may be constructed from ethylene propylene diene Monomer (M-class) (‘EPDM’) rubber. Generally, the hose 12 is a flexible structure that is capable of being manipulated, but it may also be a rigid or semi-rigid structure, or a structure with flexible and rigid portions. For example, the hose 12 may include waste removal pipes, water hoses, such as fire hoses, food industry hoses, hoses for gas transportation, and any other type of hose 12.

As is shown in FIG. 1, a cross-sectional portion of the hose 12 is located within the interior portion 22 of the hose holding structure 20. The cross-sectional portion of the hose 12 may be understood as any cross-sectional cut of hose 12 in a direction perpendicular to the length of the hose 12. The hose holding structure 20 may be a substantially circular structure with an open interior portion 22, capable of allowing the hose 12 to be placed therein. For example, the hose holding structure 20 may be considered to be uninterrupted, such that the hose holding structure 20 extends around the entire circumference of a cross-sectional portion of the hose 12. The uninterrupted design of the hose holding structure 20 may, for example, define the interior portion 22, however in other examples, the interior portion 22 may be defined by other features of the hose holding structure 20. The hose holding structure 20 may be constructed from metal, such as aluminum or steel, or any other material, such as hardened plastic. The hose holding structure 20 may have any size diameter, such as 2″, 3″, 4″ and/or 6″, as well as any other size. It may be preferable for the hose holding structure 20 to be sized to snugly fit the exterior diameter of the hose 12, such that the interior portion 22 of the hose holding structure 20 is ¼″ or ½″ larger than the exterior diameter of a hose 12. However, the hose holding structure 20 may be large enough to slide over any hose fittings, such as nozzles.

The substantially rigid connecting member 30 may be constructed from any type of material, such as aluminum or steel, and has a first end 32 that is connected or secured to the hose holding structure 20. The connection between the two structures may be a permanent or non-permanent connection, including a welded connection, a threaded fastener, or any other type of fastener. The substantially rigid connecting member 30 may have any width, diameter, and length, such that it will be convenient for use. Of course, the substantially rigid connecting member 30 may be fully rigid, but will commonly have a bit of flexibility to prevent damage, or to provide for an easier use. The handle 40 is affixed or secured to the second end 34 of the substantially rigid connecting member 30. The handle 40 may be constructed from any material, and may be design for ergonomic use. This may include a substantially cylindrical design (as is shown in FIG. 1), or any other type of handle.

The hose holding structure 20, substantially rigid connecting member 30, and handle 40 may be permanently affixed together in any combination, or removably connected together. It is also noted that the components discussed herein may be formed integral together, or more components may be included, all of which are considered within the scope of the present disclosure. For example, the hose holding structure 20 may be integrally secured into the sidewall of a hose 12 and may have a fastening area where the substantially rigid connecting member 30 is attached as needed. Also, the apparatus 10 may be viewed as a system, where the individual components are interchangeable. For example, the apparatus 10 may be commercially sold with a plurality of hose holding structures 20 and a plurality of substantially rigid connecting members 30, all of which may be different sizes. This may allow for convenient use in all situations.

In use, the hose holding structure 20 may be placed over the end of the hose 12 and used along any length of the hose 12. A worker may then grasp the handle 40 to maneuver or relocate the hose 12. For example, the worker may use the apparatus 10 to pull the end of the hose 12 from one location to another, or to steady the hose 12 as it is lowered into a septic tank. Similarly, a firefighter may use the apparatus 10 to quickly drag the hose 12 into position, as opposed to the standard method of carrying the end of the hose over his or her shoulder. The apparatus 10 may allow for use of a hose 12 without having direct contact to the hose 12. This may prevent unnecessary contamination of a worker's hands or clothing from a dirty hose 12.

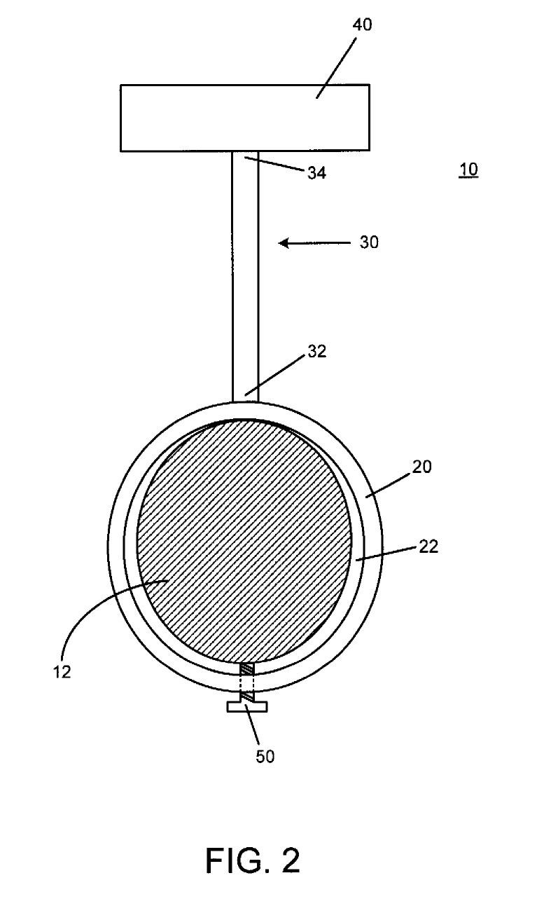

FIG. 2 is a cross-sectional illustration of a hose retention apparatus 10 with a hose-clamping element 50, in accordance with the first exemplary embodiment of the present disclosure. The hose-clamping element 50 may be any structure, or combination of structures, at least partially positioned in the interior portion 22 of the hose holding structure 20 to retain the hose 12 within the interior portion 22. For example, the hose-clamping element 50 may be a threaded element that is threaded through a hole in the hose holding structure 20, such that the hose-clamping element 50 is movably fastened to the hose holding structure 20, as is shown in FIG. 2. In other designs, the hose-clamping element 50 may be integrally connected to the first end 32 of the substantially rigid connecting member 30. For example, in this design, a threaded interface may be formed between the hose holding structure 20 and the substantially rigid connection member 30 at the first end 32.

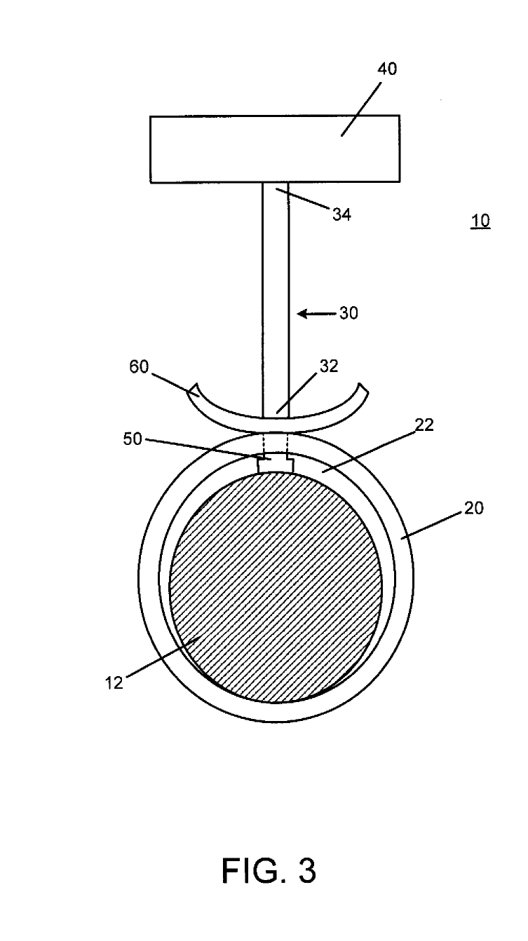

Once a hose 12 is inserted into the interior portion 22, a worker may manipulate the hose-clamping element 50 to bias the hose 12 against the interior wall of the hose holding structure 20, or otherwise retain the hose 12 within the interior portion 22. The hose-clamping element 50 may use any number of items, including springs, friction fit materials, threaded structures, ergonomic structures, or any combination thereof, all of which are considered within the scope of the present disclosure. Furthermore, the hose-clamping element 50 may be located along any part of the hose holding structure 20, such as opposing the substantially rigid connecting member 30 as is shown in FIG. 2, or proximate to the substantially rigid connecting member 30, as shown in FIG. 3.

FIG. 3 is a cross-sectional illustration of a hose retention apparatus 10 with a hose-clamping element 50 and a locking element 60, in accordance with the first exemplary embodiment of the present disclosure. As shown, the hose-clamping element 50 may be located proximate to the substantially rigid connecting member 30, and may also be an extension of the substantially rigid connecting member 30, which is threaded through the hose holding structure 20. The locking element 60 may be used with or without the hose-clamping element 50, to lock the substantially rigid connecting member 30 into place with the hose holding structure 20, which may be especially needed when the components of the apparatus 10 are removably connected to one another. For example, the locking element 60 may be a threaded structure, threaded on the substantially rigid connecting member 30, which can be tightened or moved towards the hose holding structure 20, thereby providing a force on the hose holding structure 20. This may retain the hose holding structure 20 in a substantially stationary position with respect to the substantially rigid connecting member 30. Other designs of the locking element 60 are considered within the scope of the present disclosure.

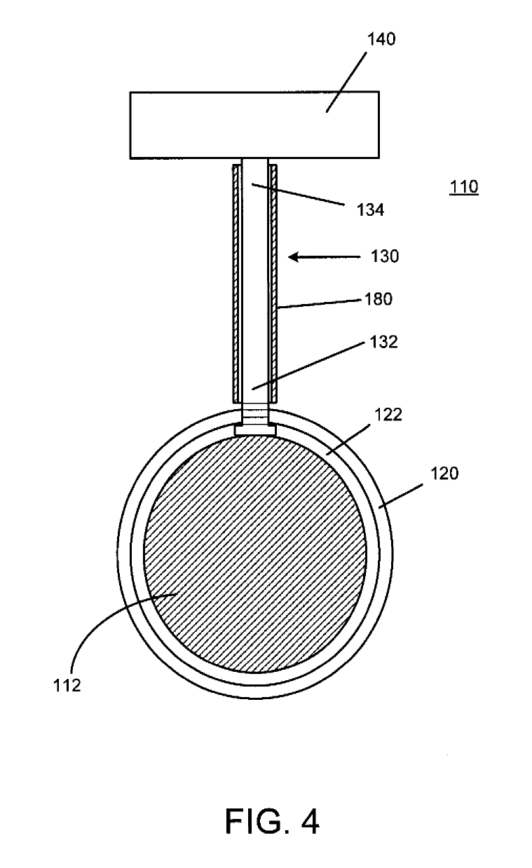

FIG. 4 is a cross-sectional illustration of a hose retention apparatus 110, in accordance with a second exemplary embodiment of the present disclosure. The hose retention apparatus 110 of the second exemplary embodiment, which may be referred to as ‘apparatus 110,’ may be substantially similar to the hose retention apparatus 10 of the first exemplary embodiment, and may include any of the parts, components, features, or functions disclosed with respect any other embodiment of this disclosure. As shown in FIG. 4, the apparatus 110 includes a hose holding structure 120 has an interior portion 122 sized to hold a cross-sectional area of a hose 112 without contacting a fluid path within the hose 112. A substantially rigid connecting member 130, having a first end 132 and a second end 134 is secured to the hose holding portion 120 at the first end 132. A handle 140 is secured to the substantially rigid connecting member 130 at the second end 134. A sleeve 180 is positioned around the substantially rigid connecting member 130 between the hose holding structure 120 and the handle 140. The sleeve 180 may be constructed from any material and may offer benefits in protecting the substantially rigid connecting member 130 from damage or other harm. For example, the sleeve 180 may prevent damage to threading formed on the exterior surface of the substantially rigid connecting member 130.

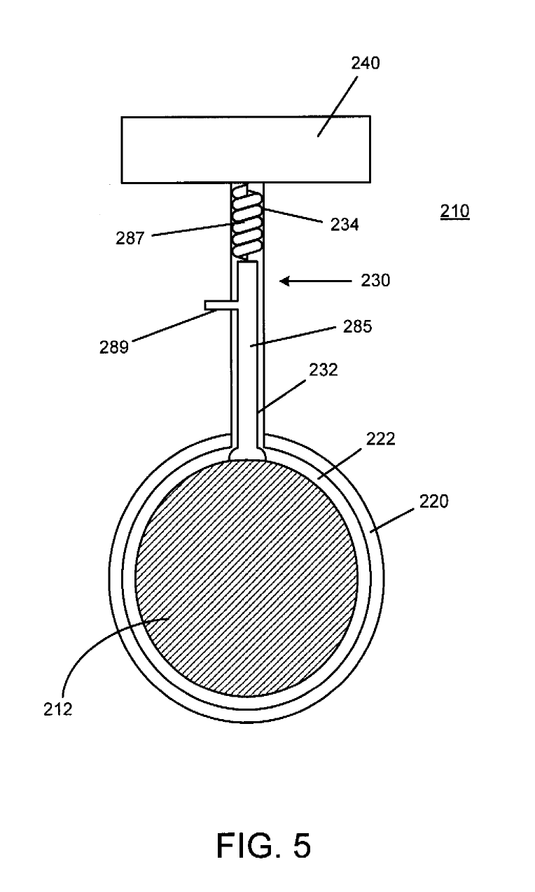

FIG. 5 is a cross-sectional illustration of a hose retention apparatus, in accordance with a third exemplary embodiment of the present disclosure. The hose retention apparatus 210 of the third exemplary embodiment, which may be referred to as ‘apparatus 210,’ may be substantially similar to the hose retention apparatus 10 of the first exemplary embodiment, and may include any of the parts, components, features, or functions disclosed with respect any other embodiment of this disclosure. As shown in FIG. 5, the apparatus 210 includes a hose holding structure 220 which has an interior portion 222 sized to hold a cross-sectional area of a hose 212 without contacting a fluid path within the hose 212. A substantially rigid connecting member 230, having a first end 232 and a second end 234 is secured to the hose holding portion 220 at the first end 232. A handle 240 is secured to the substantially rigid connecting member 230 at the second end 234.

As is shown in FIG. 5, the substantially rigid connecting member 230 is substantially hollow. A spring-biased rod 285 is positioned within the substantially rigid connecting member 230. The spring-biased rod 285 extends through the hose holding structure 220 such that it can contact the hose 212 either at the first end 232 of the substantially rigid connecting member 230 or with a hose holding structure 220 connected to the spring-biased rod 285. A spring 287 is positioned within the substantially rigid connecting member 230 between the spring-biased rod 285 and the handle 240. A control arm 289 may be affixed to the spring-biased rod 285 to control the movement of the spring-biased rod 285 within the substantially rigid connecting member 230. A user of the apparatus 210 may use the control arm 289 to move the spring-biased rod 285 within the substantially rigid connecting member 230, thereby contacting the hose 212 with the spring-biased rod 285 within the interior portion 222 of the hose holding structure 220.

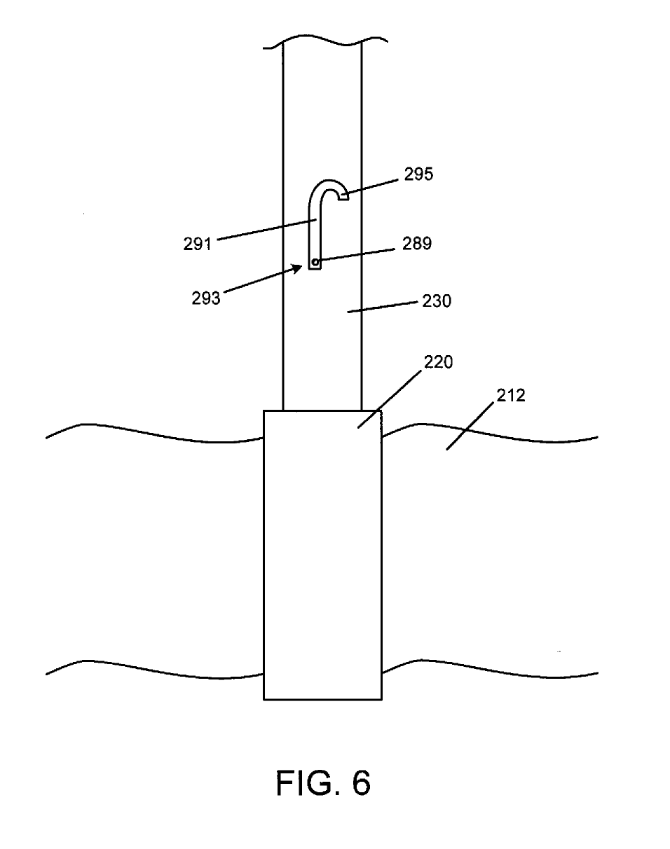

FIG. 6 is a side view illustration of a hose retention apparatus 210, in accordance with the third exemplary embodiment of the present disclosure. The control arm 289 may be affixed to the spring-biased rod 285 and extend through a slot 291 positioned in the substantially rigid connecting member 230. The slot 291 positioned in the substantially rigid connecting member 230 may include an engagement area 293 and a non-engagement area 295, wherein the control arm is movable to both the engagement and non-engagement areas 293, 295 of the slot 291. For example, in use, when the control arm 289 is not being moved by a user, it may reside in the engaged area 293 of the slot 291. In this position, the spring-biased rod 285 may be positioned within the interior portion 222 of the hose holding structure 220 to contact a hose 212.

However, when the user desires to move the hose holding structure 220 relative to the hose 212, i.e., remove the apparatus 210 from the hose 212, move the apparatus 210 along the hose 212, or place the apparatus 210 along a portion of the hose 212, the user may engage the control arm 289. The control arm 289 may be moved from the engagement area 293 to the non-engagement area 295. When the control arm 289 is in the non-engagement area 295, the spring-biased rod 285 may be removed from contact with the hose 212 within the interior portion 222. The slot 291 may include a variety of shapes, such as an inverted J shape, as is shown in FIG. 6. With the inverted J shape, the slot 291 may allow the control arm 289 to stay within the non-engagement area 295 without a user having to continually hold it there. For example, the non-engagement area 295 of the slot 291 may prevent the control arm 289 from being slid into the engagement area 293 unintentionally. Thus, a user may place the control arm 289 in the non-engagement area 295 while he or she is moving the hose holding structure 220 along the length of the hose 212, and then move the control arm 289 into the engagement area 293 of the slot 291 at the desired location to clamp the hose 212 with the spring-biased rod 285.

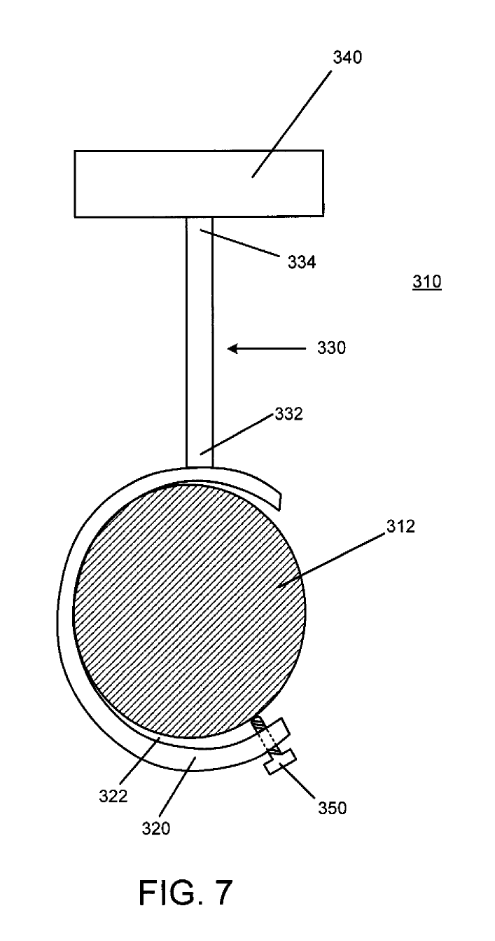

FIG. 7 is a cross-sectional illustration of a hose retention apparatus 310, in accordance with a fourth exemplary embodiment of the present disclosure. The hose retention apparatus 310, which may be referred to simply as, ‘apparatus 310’ is substantially similar to the apparatus 10 of the first exemplary embodiment, as discussed with respect to FIGS. 1-4. Accordingly, the apparatus 310 may include any of the components, features, and/or designs discussed with respect to the apparatus 10. As is shown in FIG. 7, the apparatus 310 includes a hose holding structure 320. The hose holding structure 320 has an interior portion 322 sized to hold a cross-sectional area of a hose 312. The hose holding structure 320 may have a cutout of material, thereby defining a ‘C’ shape and allowing the interior portion 322 to be open. A substantially rigid connecting member 330, having a first end 332 and a second end 334 is secured to the hose holding portion 320 at the first end 332. A handle 340 is secured to the substantially rigid connecting member 330 at the second end 334.

The cutout portion of the hose holding structure 320 may allow for quick and convenient insertion of the hose 312 into the hose holding structure 320. For example, instead of slipping the hose holding structure 320 over the end of the hose 312, and any fitting thereon, a worker may simply force the hose 312 through the cutout portion of the hose holding structure 320. A hose-clamping element 350 may then be used to keep the hose 312 in the desired position within the hose holding structure 320. The hose-clamping element 350 may be positioned at an edge of the C-shaped hose holding structure 320. The tolerance between the hose 312 and the hose holding structure 320 may be designed to allow for easy insertion of the hose 312, but prevent unintended removals of the hose 312 from the hose holding structure 320. Similarly, the size and shape of the cutout may be designed to provide successful use of the apparatus 310.

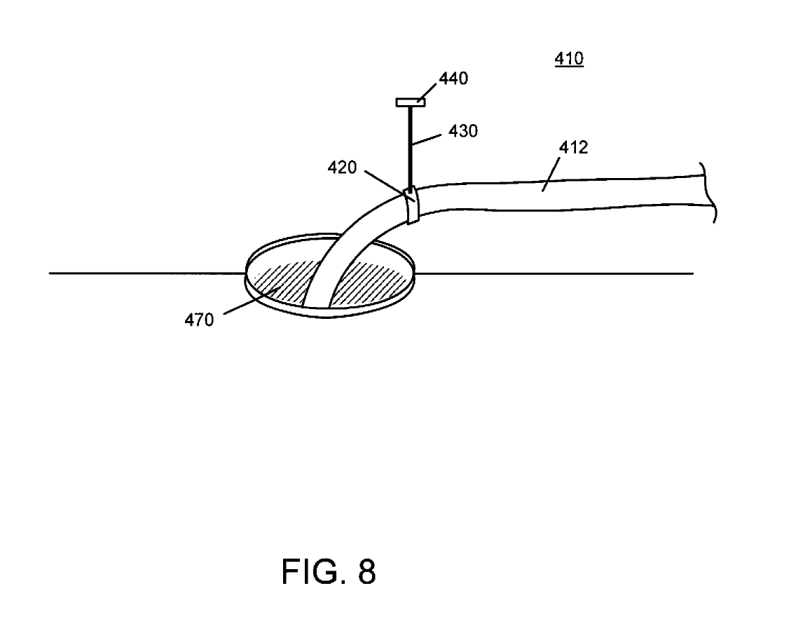

FIG. 8 is an illustration of a hose retention apparatus 410 in use, in accordance with a fifth exemplary embodiment of the present disclosure. A worker (not shown) may use the apparatus 410 to remove waste from a waste storage area 470. The worker may use the substantially rigid connecting member 430 with the handle 440 to move, hold, or relocate the end of the hose 412. The worker may be able to do this without having to directly contact the hose 412, without having to bend over or kneel, while maintaining control over the hose 412 in all directions. When a vacuum pump initiates, the hose 412 may suddenly move due to the quantity of waste being moved. When this occurs, the worker may be able to retain control and prevent the end of the hose 412, or whichever portion of the hose 412 the apparatus 410 is proximate to, from moving.

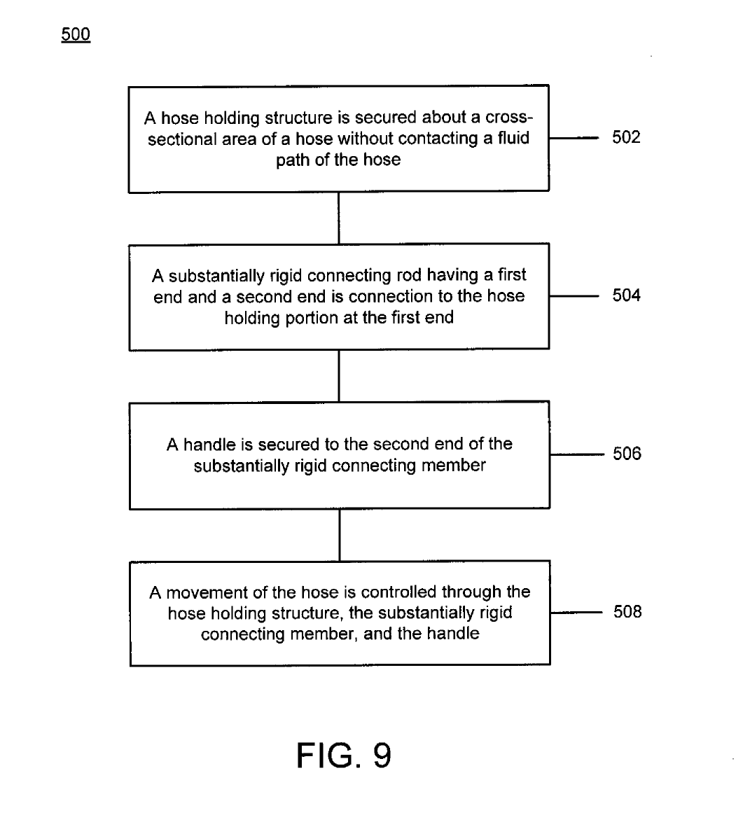

FIG. 9 is a flowchart 500 illustrating a method of retaining a hose in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 502, a hose holding structure is secured about a cross-sectional area of a hose without contacting a fluid path of the hose. A substantially rigid connecting member having a first end and a second end is connected to the hose holding portion at the first end (block 504). A handle is secured to the second end of the substantially rigid connecting member (block 506). A movement of the hose is controlled through the hose holding structure, the substantially rigid connecting member, and the handle (block 508).

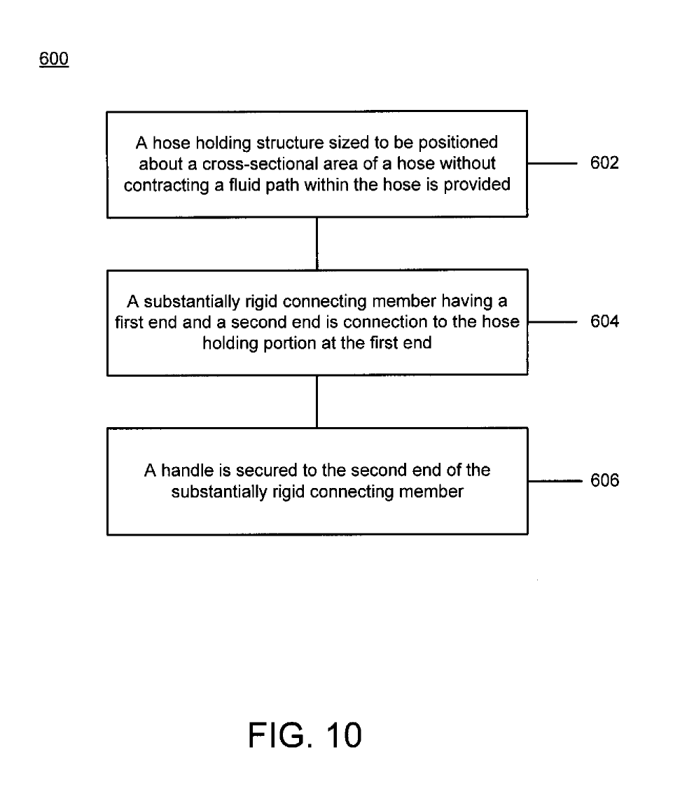

FIG. 10 is a flowchart 600 illustrating a method of building a hose retaining apparatus, in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 602, a hose holding structure sized to be positioned about a cross-sectional area of a hose without contacting a fluid path within the hose is provided. A substantially rigid connecting member having a first end and a second end is connected to the hose holding portion at the first end (block 604). A handle is secured to the second end of the substantially rigid connecting member (block 606).

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A hose retention apparatus comprising:
a hose holding structure having an interior portion sized to hold a cross-sectional area of a hose without contacting a fluid path within the hose;
a substantially rigid connecting member having a first end and a second end, wherein the first end is connected to the hose holding portion; and
a handle secured to the second end of the substantially rigid connecting member.

2. The hose retention apparatus of claim 1, wherein the hose holding structure is uninterrupted, wherein the uninterrupted hose holding structure forms the interior portion.

3. The hose retention apparatus of claim 1, further comprising a hose clamping element positioned at least partially within the interior portion of the hose holding structure.

4. The hose retention apparatus of claim 3, wherein the hose clamping element is movably fastened to the hose holding structure with a threaded connection.

5. The hose retention apparatus of claim 3, wherein the hose clamping element is integrally connected with first end of the substantially rigid connecting member.

6. The hose retention apparatus of claim 5, further comprising a threaded interface between the hose holding structure and the substantially rigid connection member at the first end.

7. The hose retention apparatus of claim 1, further comprising a sleeve positioned around the substantially rigid connecting member between the hose holding structure and the handle.

8. The hose retention apparatus of claim 1, wherein the substantially rigid connecting member is substantially hollow, wherein a spring-biased rod is positioned within the substantially rigid connecting member.

9. The hose retention apparatus of claim 8, further comprising a spring positioned within the substantially hollow rigid connection member between the spring-biased rod and the handle.

10. The hose retention apparatus of claim 8, further comprising a control arm affixed to the spring-biased rod, wherein the control arm extends through a slot within the substantially rigid connecting member.

11. The hose retention apparatus of claim 10, wherein the slot within the substantially rigid connecting member further comprises an engagement area and a non-engagement area, wherein the control arm is movable within both the engagement and non-engagement areas of the slot.

12. The hose retention apparatus of claim 8, further comprising a hose holding structure connected to the spring-biased rod.

13. The hose retention apparatus of claim 1, wherein the hose holding structure further comprises a C-shape.

14. The hose retention apparatus of claim 13, further comprising a hose clamping element positioned at an edge of the C-shaped hose holding structure.

15. A method of retaining a hose comprising the steps of:
securing a hose holding structure about a cross-sectional area of a hose without contacting a fluid path within the hose;
connecting a substantially rigid connecting member having a first end and a second end to the hose holding portion at the first end;
securing a handle to the second end of the substantially rigid connecting member; and
controlling a movement of at least a portion of the hose with the hose holding structure, the substantially rigid connecting member, and the handle.

16. The method of claim 15, further comprising the step of clamping the hose within the hose holding structure with a hose clamping element.

17. The method of claim 15, wherein the step of connecting a substantially rigid connecting member further comprises the steps of:
fastening the first end of the substantially rigid connecting member to the hose holding structure;
moving the first end of the substantially rigid connecting member into the interior portion; and
contacting the hose with the first end of the substantially rigid connecting member.

18. The method of claim 15, further comprising the step of moving a spring-biased rod within a hollow interior of the substantially rigid connecting member between a first position where the spring-biased rod contacts the hose within the interior portion of the hose holding structure and a second position where the spring-biased rod does not contact the hose within the interior portion of the hose holding structure.

19. The method of claim 18, further comprising the step of locking the spring-biased rod in the second position by placing a control arm connected to the spring-biased rod in a non-engagement position of a slot within the substantially rigid connecting member.

20. A method of building a hose retaining apparatus, the method comprising the steps of:
providing a hose holding structure sized to be positioned about a cross-sectional area of a hose without contacting a fluid path within the hose;
connecting a substantially rigid connecting member having a first end and a second end to the hose holding portion at the first end; and
securing a handle to the second end of the substantially rigid connecting member.
